(19) United States
(12) Patent Application Publication
(10) Pub. No.: US 2025/0331562 A1
(43) Pub. Date: Oct. 30, 2025

(54) HEATER MODULE AND AEROSOL GENERATING DEVICE INCLUDING SAME

(71) Applicant: KT&G CORPORATION, Daejeon (KR)

(72) Inventors: Jong Sub LEE, Seongnam-si (KR); Min Seok JEONG, Seoul (KR); Byung Sung CHO, Gwangmyeong-si (KR); Jung Yong YOON, Osan-si (KR); Pill Won YOON, Bucheon-si (KR); Jong Ik LEE, Hwaseong-si (KR)

(73) Assignee: KT&G CORPORATION, Daejeon (KR)

(21) Appl. No.: 19/189,625

(22) Filed: Apr. 25, 2025

(30) Foreign Application Priority Data
Apr. 25, 2024 (KR) 10-2024-0055495

(51) Int. Cl. A24F 40/46; A24F 40/51; A24F 40/57; H05B 3/03

(52) U.S. Cl. CPC A24F 40/46; A24F 40/51; A24F 40/57; H05B 3/03

(57) ABSTRACT

The present invention may provide a heater module for heating aerosol generating material, the heater module comprising: a heater main body; a heater disposed inside the heater main body and for heating the aerosol generating material delivered from a cartridge; and a heater upper sealing member disposed on an upper side of the heater main body, wherein a portion of the heater is exposed above the heater upper sealing member.

### TECHNICAL FIELD

### Background of the Invention

An aerosol generating device includes a cartridge including a liquid storing unit containing aerosol generating material and a heater. The cartridge is removably coupled with the aerosol generating device. Power is transferred from the aerosol generating device to the cartridge. Accordingly, the aerosol generating material held in the cartridge is heated by the heater.

Once the aerosol generating material stored in the cartridge has been exhausted, the cartridge may be replaced. However, because in general the period during which the durability of the heater is maintained is longer than the period during which aerosol generating material is exhausted, the heater may be unnecessarily replaced despite being more usable.

### CONTENT OF THE INVENTION

### Problem to be Solved

In view of the foregoing, an object of the present invention is to provide a heater module capable of separating a heater from a cartridge to promote reuse of the heater, and an aerosol generating device including the heater module.

The problem to be solved by the present invention is not limited to the above-mentioned problem, and other problems not mentioned here will be clearly understood by those skilled in the art from the following description.

### Method for Solving Problem

There may be provided a heater module for heating aerosol generating material, the heater module including: a heater main body; a heater disposed inside the heater main body and for heating the aerosol generating material delivered from a cartridge; and a heater upper sealing member disposed on an upper side of the heater main body, wherein a portion of the heater is exposed above the heater upper sealing member.

A heater control unit may be further included, wherein the heater control unit may include a counting unit configured to count the number of puffs.

A heater control unit may be further included, wherein the heater control unit may include a switch that is turned on and off by an external force, and some of the terminal units of the switch may be exposed to the outside of the heater main body.

The terminal unit of the switch may include a first terminal connected to the heater control unit, a second terminal connected to the heating control unit and spaced apart from the first terminal, and a switching terminal connected to the first terminal, and one end of the switching terminal may be connected to the first terminal and the other end thereof is disposed to be spaced apart from the second terminal, and the other end may be positioned to be in contact with the second terminal by being elastically deformed by an external force.

The switching terminal may include a receiving unit that is horizontally disposed and receives an external force in a vertical direction.

The heater upper sealing member may include a side wall forming an accommodation space inside; a through hole that is disposed inside the side wall and configured to communicate an upper side and a lower side of the heater upper sealing member; and a first conduit disposed inside the side wall and configured to communicate an upper side and a lower side of the heater upper sealing member.

A heater control unit may be further included, wherein the heater control unit may include a switch that is turned on and off by an external force, and a portion of the terminal units of the switch may be exposed to the outside of the heater main body, and wherein the heater upper sealing member may include a switch hole disposed outside the side wall, and the switch hole may be aligned with the terminal unit of the switch.

A first heater holder and a second heater holder that are disposed between the heater and fix the heater may be further included, wherein the first heater holder may include a through hole communicating the upper and lower sides of the first heater holder, and a second conduit communicating the upper and lower sides of the first heater holder, and the through hole of the heater upper sealing member and the through hole of the first heater holder may be arranged in alignment; and the first conduit and the second conduit may be arranged in alignment.

The second holder may include a receiving groove for receiving the heater, and be made of an elastically deformable material and surround the heater.

A heater housing disposed inside the heater main body and disposed outside the first heater holder and the second heater holder, and a heater cover coupled to an upper side of the heater main body may be further included, wherein the heater upper sealing member may be disposed to surround an upper portion of the heater housing, and seal between the heater cover and the heater housing.

A heater lower sealing member disposed to surround a lower portion of the heater housing may be further included, wherein the heater lower sealing member may seal between the main body and the heater housing.

Embodiments may provide an aerosol generating device, including: a main body; a heater module removably coupled to the main body and including: a heater for heating aerosol generating material; and a cartridge removably coupled to the main body to retain the aerosol generating material to be delivered to the heater; wherein the heater module includes: a heater main body; a heater disposed inside the heater main body and for heating the aerosol generating material delivered from the cartridge; and a heater upper sealing member disposed on an upper side of the heater main body, wherein a portion of the heater is exposed above the heater upper sealing member.

The cartridge may include a hygroscopic body, and a portion of the heater exposed above the heater upper sealing member may be in contact with the hygroscopic body.

The cartridge may include a protruding recognition protrusion, and the heater module may further include a heater control unit, wherein the heater control unit includes a switch that is turned on and off by contact of the recognition protrusion.

The heater upper sealing member may be in contact with the cartridge to form a space for receiving the aerosol generating material supplied from the cartridge and to seal the formed space.

A side cover detachably coupled to the heater main body may be included, the main body includes a flow path connected to a suction sensor disposed inside the main body, and a gap is formed between the main body and the side cover in a vertical direction, and when the heater module is assembled to the main body, the gap and the flow path may communicate with each other.

The heater module may form a space in which a portion of the main body and a connector of the main body are inserted in a lower portion of the heater module.

The heater module may include a connection terminal connected to the heater control unit, the connecting terminal may be exposed in a space into which a portion of the main body and the connector of the main body are inserted; and when the heater module is assembled to the main body, the connection terminal may be in electrical contact with the connector.

### Effects of the Invention

According to an embodiment, by separating the cartridge and the heater module, there is an advantage that reuse of the heater module can be promoted.

According to an embodiment, there is an advantage of being able to recognize the connection of the cartridge in the heater module.

According to an embodiment, there is an advantage of preventing the aerosol generating material from leaking out of the cartridge through the sealing member.

According to an embodiment, when the cartridge is assembled with the heater module, there is an advantage of preventing the aerosol generating material from leaking.

### BRIEF DESCRIPTION OF THE DRAWINGS

FIG. 1 is a schematic view of an aerosol generating device including a heater module according to an embodiment.

FIG. 2 is a perspective view of an aerosol generating device according to an embodiment.

FIG. 3 is a cross-sectional side view of an aerosol generating device according to an embodiment with reference to A-A of FIG. 2.

FIG. 4 is an exploded view of an aerosol generating device according to an embodiment.

FIG. 5 is a perspective view illustrating a heater module.

FIG. 6 is an exploded view of the heater module shown in FIG. 5.

FIG. 7 is a view illustrating a heater upper sealing member.

FIG. 8 is a view illustrating a first heater holder.

FIG. 9 is a perspective view illustrating a heater.

FIG. 10 is a diagram illustrating a structure for supplying electricity to a heater.

FIG. 11 is a view showing the direction of the airflow and the direction of the aerosol in a heater.

FIG. 12 is a side cross-section of the heater module with reference to B-B of FIG. 5.

FIG. 13 shows a block illustrating a heater control unit.

FIG. 14 shows a cartridge including a recognition protrusion.

FIG. 15 is a view showing a structure of a heater module into which the recognition protrusion of the cartridge shown in FIG. 14 is inserted.

FIG. 16 is a perspective view illustrating a switch.

FIG. 17 is an exploded view of a cartridge.

FIG. 18 is a side cross-sectional view of the periphery of the heater when a cartridge is connected with a heater module.

FIG. 19 shows a connecting terminal connected to a main body.

FIG. 20 is a side cross-sectional view illustrating a suction sensor disposed in a main body and a path of outside air communicating with the suction sensor.

### DETAILED CONTENTS FOR CARRYING OUT THE INVENTION

Hereinafter, embodiments disclosed in the present specification will be described in detail with reference to the accompanying drawings, and the same or similar components will be denoted by the same reference numerals regardless of the reference numeral and redundant description thereof will be omitted.

The suffixes “module” and “unit” for components used in the following description are given or used interchangeably only in consideration of ease of description, and do not have distinct meanings or roles from each other.

In addition, in the description of the embodiments disclosed in the present specification, if it is determined that the specific description of the related known technology may obscure the gist of the embodiments disclosed herein, the detailed description thereof will be omitted. In addition, it should be understood that the accompanying drawings are merely for facilitating understanding of the embodiments disclosed in this specification, and are not intended to limit the technical concept disclosed in this specification by the accompanying drawings, and include all modifications, equivalents, and alternatives included in the concept and technical scope of this disclosure.

Although ordinal terms such as first, second, etc. may be used to describe various elements, the elements are not limited by the terms. The terms are only used for the purpose of distinguishing one component from another.

It will be understood that when an element is referred to as being “connected” or “coupled” to another element, it may be directly connected or coupled to the other element, but intervening elements may also be present. In contrast, when an element is referred to as being “directly connected” or “directly coupled” to another element, it should be understood that there are no intervening elements present.

The singular forms “a,” “an,” and “the” include plural referents unless the context clearly dictates otherwise.

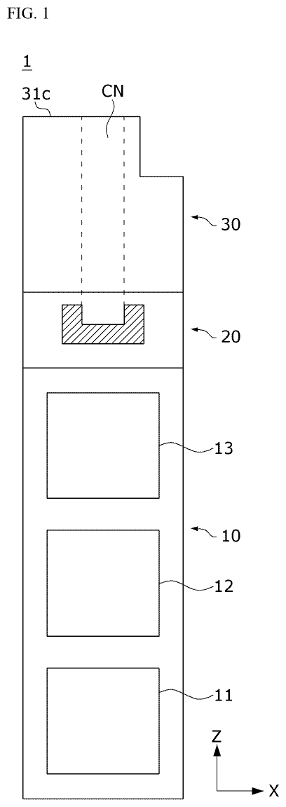

FIG. 1 is a schematic view of an aerosol generating device including a heater module according to an embodiment.

Hereinafter, in the drawings, an x-axis represents a width direction x of an aerosol generating device 1 including a heater module 20, a y-axis represents a thickness direction of the aerosol generating device 1 including the heater module 20, and a z-axis represents a length direction of the aerosol generating device 1 including the heating module 20.

Hereinafter, “upward and downward,” “upper,” “upper end,” “lower,” “lower end,” “above,” and “below” refer to the z axis in the drawings.

Referring to FIG. 1, the aerosol generating device 1 may include a main body 10, a heater module 20, and a cartridge 30.

The main body 10 may include at least one of a power source 11, a control unit 12, and a sensor 13. The cartridge 30 may be mounted to the main body 10.

The power source 11 may supply power to the components of the aerosol generating device 1 to operate. The power source 11 may be referred to as a battery. The power source 11 may supply power to at least one of the control unit 12, the sensor 13, and the heater module 20.

The control unit 12 may control the overall operation of the aerosol generating device 1. The control unit 12 may be mounted on a printed circuit board (PCB). The control unit 12 may control an operation of at least one of the power source 11, the sensor 13, and the cartridge 30. The control unit 12 may control the operation of a display, a motor, or the like provided in the aerosol generating device 1. The control unit 12 may check the state of each of the configurations of the aerosol generating device 1 to determine whether the aerosol generating device is in an operable state.

The control unit 12 may analyze the result sensed by the sensor 13 and control processes to be performed thereafter. For example, the control unit 12 may control, based on a result sensed by the sensor 13, the power supplied to the heater module 20 so that the operation of the heater module 20 is started or ended. For example, based on the result sensed by the sensor 13, the control unit 12 may control the amount of power supplied to the heater module 20 and the time at which the power is supplied so that the heater module 20 may be heated to a predetermined temperature or may maintain an appropriate temperature.

The sensor 13 may include at least one of a temperature sensor, a puff sensor, a cartridge sensing sensor, and a motion sensing sensor. For example, the sensor 13 may sense at least one of a temperature of the heater module 20, a temperature of the power source 11, and a temperature inside and outside the main body 10. For example, the sensor 13 may sense a puff of the user. For example, the sensor 13 may sense whether the cartridge 30 is mounted. For example, the sensor 13 may sense movement of the aerosol generating device 1.

The heater module 20 may be detachably mounted on the main body 10. The heater module 20 may be positioned between the cartridge 30 and the main body 10 to convert a phase of aerosol generating material into a phase of a gas to generate an aerosol. The heater module 20 may heat the aerosol generating material supplied from the cartridge 30 to generate an aerosol.

For example, the heater module 20 may heat the aerosol generating material supplied from the cartridge 30 to generate a vapor from the aerosol generating material. The generated vapor may be mixed with external air introduced into the interior of the heater module 20 from outside the heater module 20 to generate an aerosol. In an embodiment, “aerosol” may refer to particles produced by mixing air with vapor produced by heating aerosol generating material, and the expression may be used hereinafter in the same sense.

The cartridge 30 may be detachably mounted to the main body 10. The cartridge 30 may be located above the heater module 20. The cartridge 30 has aerosol generating material stored therein. The aerosol generating material stored in the cartridge 30 is supplied to the heater module 20. The cartridge 30 may include a mouthpiece 30a. When a user sucks the mouthpiece 30a with his/her mouth, the user may inhale aerosol discharged to the outside of the aerosol generating device 1.

Outside air introduced into the main body 10 may pass through the cartridge 30 and flow through the airflow channel CN to the user's mouth.

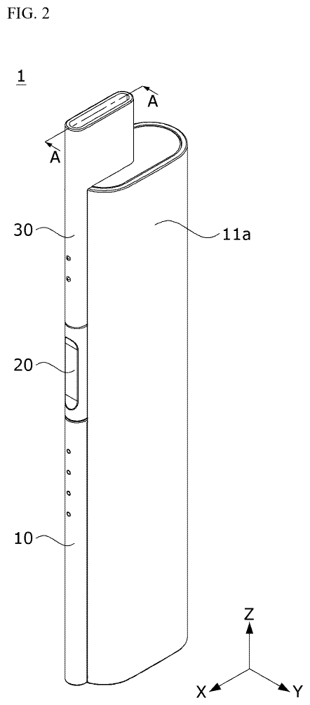

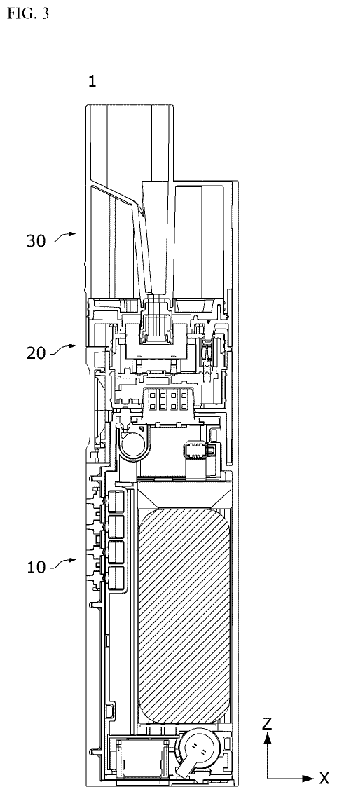

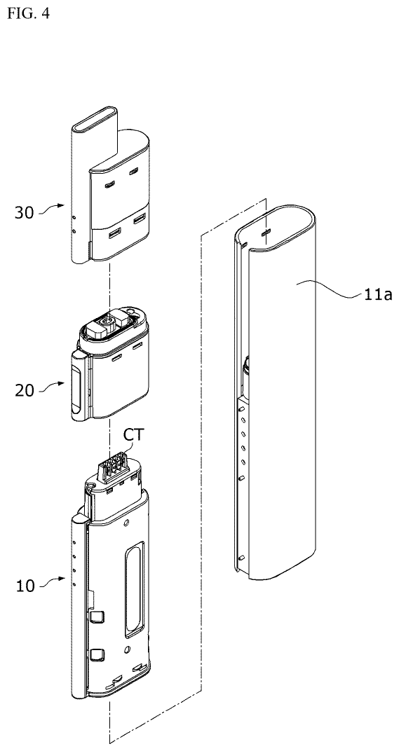

FIG. 2 is a perspective view of an aerosol generating device according to an embodiment, FIG. 3 is a cross-sectional side view of the aerosol generating device according to an embodiment with reference to A-A of FIG. 2, and FIG. 4 is an exploded view of an aerosol generating device according to an embodiment.

Referring to FIGS. 2 to 4, the aerosol generating device 1 according to an embodiment may include a main body 10, a heater module 20, and a cartridge 30.

The main body 10 is located at a lower end of the heater module 20, and may support the heater module 20. A power source 11 and a control unit 12 for operation of the aerosol generating device 1 may be disposed inside the main body 10. The main body 10 may be arranged with a user interface and display means for visually informing the operating state or the battery state. A mouthpiece 31C may protrude from an upper end of the main body 10.

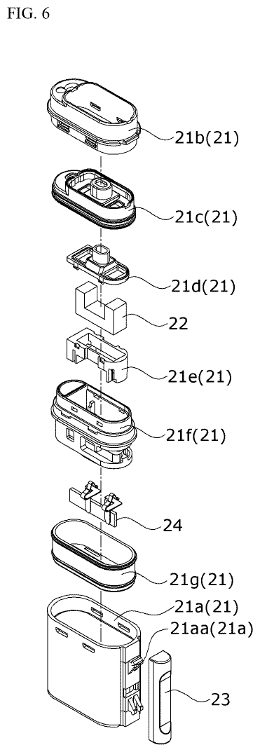

The heater module 20 may be disposed on an upper side of the main body 10. The heater module 20 may be detachably coupled to the main body 10. The heater module 20 that has passed the target number of uses may be replaced with a new one. Such a heater module may include a heater (e.g., heater 22 in FIG. 6).

The cartridge 30 may be disposed on an upper side of the heater module 20. The cartridge 30 may be detachably coupled to the main body 10 with the heater module 20 interposed therebetween.

The aerosol generating device 1 according to an embodiment may further include a cover 11a. The cover 11a may form a space for accommodating the main body 10, the heater module 20, and the cartridge 30 inside. The cover 11a may be formed to surround at least a partial region of the main body 10, the heater module 20, and the cartridge 30. The cover 11a determines the positions of the main body 10, the heater module 20, and the cartridge 30, respectively. The cover 11a may serve to protect the main body 10, the heater module 20, and the cartridge 30 from external impact or inflow of foreign matter.

The cover 11a may be integrally formed with the main body 10, but the present invention is not limited thereto.

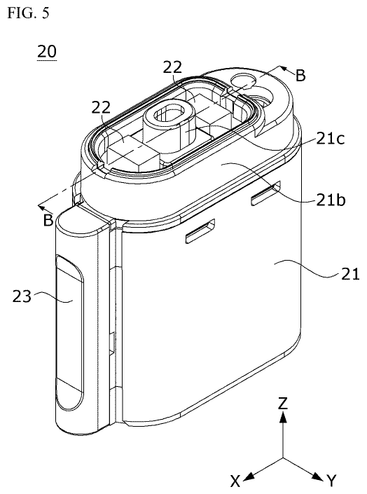

Hereinafter, the heater module 20 will be specifically described with reference to FIGS. 5 to 12.

FIG. 5 is a perspective view showing the heater module 20, and FIG. 6 is an exploded view of the heater module 20 shown in FIG. 5.

Referring to FIGS. 5 and 6, the heater module 20 may include a heater main body 21, a heater 22, and a side cover 23.

The heater main body 21 may have a structure for fixing the heater 22. The heater main body 21 may include a terminal connected to the heater 22, a flow path structure through which the aerosol generating material supplied from the cartridge moves, and the like. The upper end portion of the heater main body 21 may include a connection structure for connection with the cartridge. The lower end of the heater main body 21 may include a receiving structure in which a connector (e.g., connector CT of FIG. 4) of the main body 10 is received.

A specific configuration of the heater main body 21 is as follows.

The heater main body 21 may include a heater module housing 21a, a heater cover 21b, a heater upper sealing member 21c, a first heater holder 21d, a second heater holder 21e, a heater housing 21f, and a heater lower sealing member 21g.

The heater module housing 21a may form the appearance of the heater module 20. The heater cover 21b may be coupled to an upper end of the heater module housing 21a. The heater upper sealing member 21c may be fixed to the heater cover 21b. The heater upper sealing member 21c may be located inside the heater cover 21b. The first heater holder 21d may serve to fix the heater 22 and form a flow path through which the aerosol passes. The first heater holder 21d may be in contact with the heater upper sealing member 21c. The first heater holder 21d may be coupled to the heater housing 21f. The second heater holder 21e may serve to wrap the lower end of the heater 22. The second heater holder 21e may be made of an elastically deformable material. The heater housing 21f may fix a terminal connected to the heater 22 and provide a space for accommodating a switch that recognizes the cartridge 30. Further, the heater housing 21f may serve to fix the heater 22. The heater lower sealing member 21g may be disposed between the heater module housing 21a and the heater housing 21f to prevent liquid leakage due to liquefaction of the remaining aerosol. A substrate 24 is located inside the heater module housing 21a.

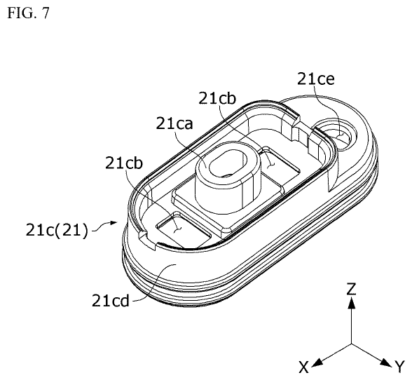

FIG. 7 is a view illustrating the heater upper sealing member 21c.

Referring to FIG. 7, the heater upper sealing member 21c may serve to seal the open upper end portion of the heater main body 21. The heater upper sealing member 21c may form a space for accommodating the aerosol, and may seal the heater main body 21 so that the accommodated aerosol does not leak.

And, the heater upper sealing member 21c may be in contact with the cartridge 30. The heater upper sealing member 21c may form a structure that receives the aerosol generating material supplied from the cartridge 30. The heater upper sealing member 21c may include a first conduit 21ca. The first conduit 21ca may be disposed at the center of the heater upper sealing member 21c. This first conduit 21ca may be connected with an airflow channel CN disposed in the cartridge 30. The heater upper sealing member 21c may include a through hole 21cb. For example, two through holes 21cb may be disposed with the first conduit 21ca interposed therebetween. A portion of the heater 22 may be exposed to the outside of the heater module 20 through the through hole 21cb.

The heater upper sealing member 21c may include a side wall 21cd. The side wall 21cd may be disposed outside the through hole 21cb and the first conduit 21ca. The side wall 21cd may be disposed to surround the through hole 21cb and the first conduit 21ca. When the cartridge 30 is connected to the heater module 20, the side wall 21cd may be in contact with the lower surface of a second case 32 to serve to seal the inner space of the side wall 21cd.

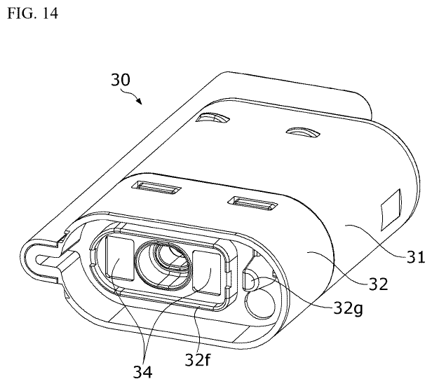

Meanwhile, the heater upper sealing member 21c may include a switch hole 21ce. The switch hole 21ce may be disposed outside the side wall 21cd. A recognition protrusion 32g in FIG. 14 of the cartridge 30 may pass through the switch hole 21ce.

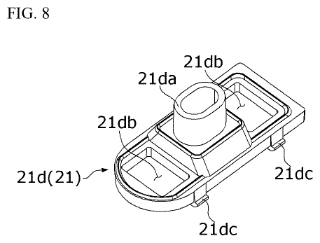

FIG. 8 is a diagram illustrating the first heater holder 21d.

Referring to FIG. 8, the first heater holder 21d may include a second conduit 21da. The second conduit 21da may be in contact with the first conduit 21ca of the heater upper sealing member 21c. The first heater holder 21d may include a through hole 21db. For example, two through holes 21db may be disposed with the second conduit 21da interposed therebetween. The through hole 21db of the first heater holder 21d may be arranged in alignment with the through hole 21cb of the heater upper sealing member 21c. The first heater holder 21d may include a hook-shaped fastening unit 21dc. The fastening unit 21dc may be disposed at an edge of the first heater holder 21d. The first heater holder 21d may be coupled to the second heater holder 21e through a fastening unit 21dc.

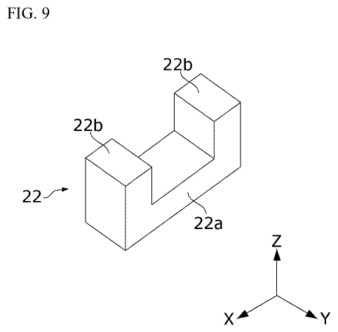

FIG. 9 is a perspective view illustrating the heater 22.

The heater 22 may be fixed to the heater main body 21 such that a portion of the heater 22 is exposed to the outside of the heater module 20. A portion of the exposed heater 22 may contact a hygroscopic body 34 of the cartridge 30.

A specific configuration of the heater 22 is as follows.

Referring to FIG. 9, the heater 22 may include a heater body 22a having a hexahedral shape, and side wall units 22b protruding vertically upward at both ends of the heater body 22a, respectively. For example, the heater body 22a and the side wall unit 22b may be disposed to have a U-shape when viewed from the front. An end portion of the side wall unit 22b may penetrate the through hole 21db of the first heater holder 21d and the through hole 22db of the heater upper sealing member 21c and protrude further than the heater upper sealing member 21c. The end of the protruding sidewall unit 22b may contact the hygroscopic body 34 of the cartridge 30.

This heater 22 may be formed of any electrically resistive material. For example, the electrically resistive material may be a metal or metal alloy including titanium, zirconium, tantalum, platinum, nickel, cobalt, chromium, hafnium, niobium, molybdenum, tungsten, tin, gallium, manganese, iron, copper, stainless steel, nichrome, and the like, but the present invention is not limited thereto. For example, the heater 22 may include at least one of a coil heater coupled with silica wick and a porous ceramic heater.

As shown in FIG. 6, the side cover 23 may be detachably coupled to one side of the heater main body 21. The side cover 23 may include a groove unit for easy gripping and manipulation by a user. The side cover 23 forms an internal space and may guide the outside air so that the outside air flows into the heater main body 21. A side surface of the heater main body 21 may be provided with a coupling structure for coupling with the side cover 23. The gap between the heater main body 21 and the side cover 23 may be utilized as an inflow path of the outside air.

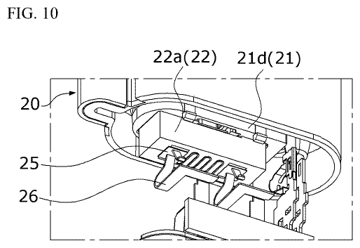

FIG. 10 is a diagram illustrating a structure for supplying electricity to the heater 22.

Referring to FIG. 10, the heater module 20 may include an electrode pattern 25. The electrode pattern 25 may be formed on the lower surface of the heater body 22a of the heater 22. The heater module 20 may include a heater terminal 26 that contacts the connection to the electrode pattern 25. The heater terminal 26 may be electrically connected with a connector (CT in FIG. 4) of the main body. When electricity is transmitted to the heater 22 through the heater terminal 26 and the electrode pattern 25, the heater 22 heats up and thus an aerosol may be generated.

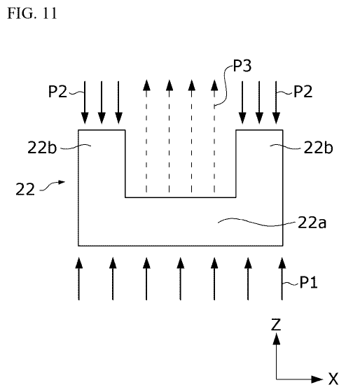

FIG. 11 is a view illustrating the direction of the airflow and the direction of the aerosol in the heater 22.

Referring to FIG. 11, the heater 22 may be disposed such that the sidewall unit 22b faces upward, and the heater body 22a may be disposed horizontally. The outside air introduced into the heater module 20 may be introduced so as to face the lower surface of the heater body 22a as shown in P1 of FIG. 11. Accordingly, the outside air flowing into the heater module 20 collides with the lower surface of the heater body 22a. Since the airflow does not flow along the outer surface of the heater 22 but collides with the outer surface of the heater 22, the generation of sludge may be greatly reduced.

As shown in P2 of FIG. 11, when aerosol generating material is supplied to the heater 22 through the side wall unit 22b and the heater 22 is heated, an airflow path of the aerosol may be formed in the center with reference to the width direction x of the heater 22 as shown in P3 of FIG. 11. As such, the aerosol generated by the heat generation of the heater 22 may be guided to the second conduit 21da of the first heater holder (21d in FIG. 8).

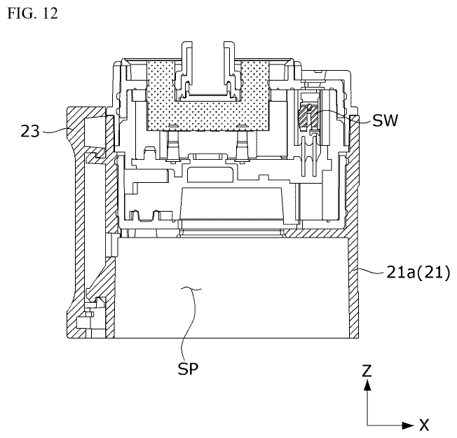

FIG. 12 is a side cross-sectional view of the heater module 20 with reference to B-B of FIG. 5.

Referring to FIG. 6 and FIG. 12 together, the heater module 20 may include a substrate 24. The substrate 24 may be electrically connected with a switch SW. The switch SW is a component for recognizing the cartridge 30. An element for counting the number of puffs and a heater resistance memory may be mounted on the substrate 24.

On the other hand, the heater module housing 21a may form a space SP in a lower unit into which a portion of the main body 10 and a connector (CT in FIG. 4) are inserted. The connector CT of the main body 10 may be electrically connected with the substrate 24 of the heater module 20. When the main body 10 and the heater module 20 are assembled, the control unit 12 of the main body 10 may be electrically connected to the substrate 24 of the heater module 20.

Hereinafter, a specific configuration of a heater control unit constituted by elements mounted on the substrate 24 will be described.

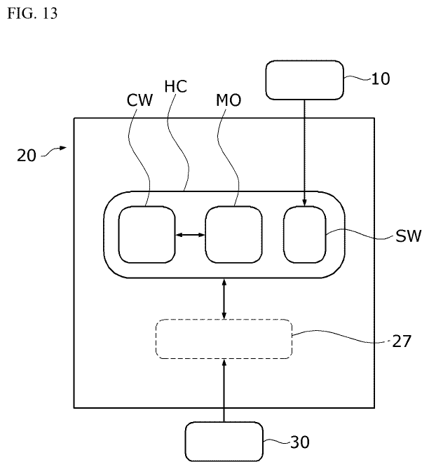

FIG. 13 is a block illustrating the heater control unit HC.

Referring to FIG. 13, the heater control unit HC may include a counting unit CW, a switch SW, and a memory MO.

The counting unit CW may count the number of puffs of the user. The counting unit CW may be connected to a suction sensor SS of the main body 10 to receive information about the user's puff. The user's puff sensed through the suction sensor SS may be delivered to the counting unit CW through the connector CT and a connecting terminal 27 of the main body 10. The number of puffs of the user counted by the counting unit CW may be stored in the memory MO. In the memory MO, a maximum allowable puff number, a current puff number, and the like that determine the life of the heater module 20 may be stored.

When the number of puffs counted by the counting unit CW reaches the maximum allowable number of puffs, the heater control unit HC may send a signal to the control unit 12 of the main body 10 to notify the user through the display device disposed in the main body 10. The heater module 20 that has reached the maximum allowable number of puffs may be replaced with a new heater module 20.

The switch SW may be turned on and off by an external force applied by the recognition protrusion 32g of the cartridge 30 to generate an electrical signal corresponding to whether or not the cartridge is mounted.

FIG. 14 is a view showing the cartridge 30 including the recognition protrusion 32g.

Referring to FIG. 14, the cartridge 30 may include a first case 31 and a second case 32. The second case 32 is in contact with the heater module 20.

The second case 32 may include a recognition protrusion 32g. The recognition protrusion 32g may protrude from the lower surface of the second case 32. The recognition protrusion 32g may be configured to physically press the switch SW disposed in the heater module 20. When the recognition protrusion 32g presses the switch SW disposed in the heater module 20, the control unit 12 of the main body 10 may thereby recognize that the cartridge 30 is connected to the heater module 20.

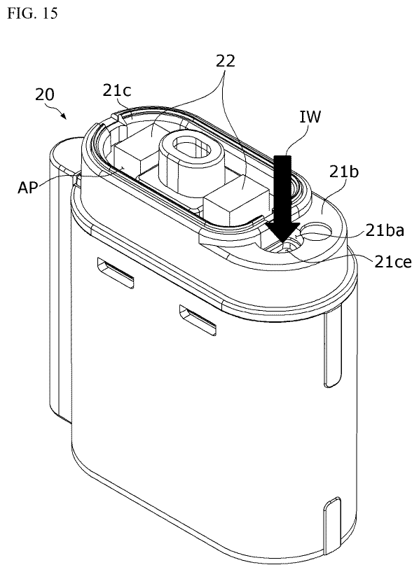

FIG. 15 is a diagram illustrating a structure of the heater module 20 into which the recognition protrusion 32g of the cartridge 30 illustrated in FIG. 14 is inserted.

Referring to FIG. 15, when the cartridge 30 is coupled to the heater module 20, the heater module 20 may have a structure in which the recognition protrusion 32g may be inserted to contact the switch SW. Specifically, the heater cover 21b may include a hole 21ba aligned with the switch hole 21ce of the heater upper sealing member 21c.

In the direction indicated by IW in FIG. 15, the recognition protrusion 32g of the cartridge 30 may be inserted. The recognition protrusion 32g may pass through the hole 21ba of the heater cover 21b and the switch hole 21ce of the heater upper sealing member 21c to contact the switch SW located inside the heater module 20.

A specific configuration of the switch SW is as follows.

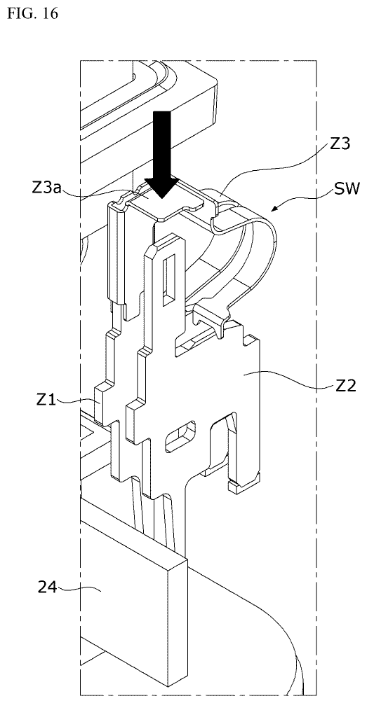

FIG. 16 is a perspective view illustrating the switch SW.

Referring to FIG. 16, the switch SW may include a first terminal Z1, a second terminal Z2, and a switching terminal Z3. A lower end of the first terminal Z1 may be connected to the substrate 24. An upper end of the first terminal Z1 may be connected to the switching terminal Z3. The lower end of the second terminal Z2 may be connected to the substrate 24.

One end of the switching terminal Z3 may be connected to the first terminal Z1, and the other end thereof may be spaced apart from the second terminal Z2. The switching terminal Z3 is elastically deformed by the recognition protrusion 32g, so that the other end of the switching terminal Z3 may be positioned in contact with the second terminal Z2.

On the other hand, the switching terminal Z3 may include a receiving unit Z3a. The receiving unit Z3a may have a planar plate shape. The receiving unit Z3a is disposed horizontally and comes into contact with the recognition protrusion 32g of the cartridge 30. As indicated by the arrow in FIG. 16, the recognition protrusion 32g moves downward and pushes the receiving unit Z3a. As the receiving unit Z3a moves, the other end of the switching terminal Z3 moves downward and comes into contact with the second terminal Z2, so that the switch SW may be switched from the OFF state to the ON state.

When the switch SW is switched to the ON state, the control unit 12 of the main body 10 may recognize that the cartridge 30 is mounted on the heater module 20. When the switch SW is switched to the ON state, the control unit 12 of the main body 10 may be implemented so that the user may visually or audibly recognize the switch SW through a separate display device or audio device provided in the main body 10.

When the cartridge 30 is detached from the heater module 20, the other end of the switching terminal Z3 is separated from the second terminal Z2 as the recognition protrusion 32g pressing the receiving unit Z3a is separated from the receiving unit Z3, so that the switch SW may be switched from the ON state to the OFF state.

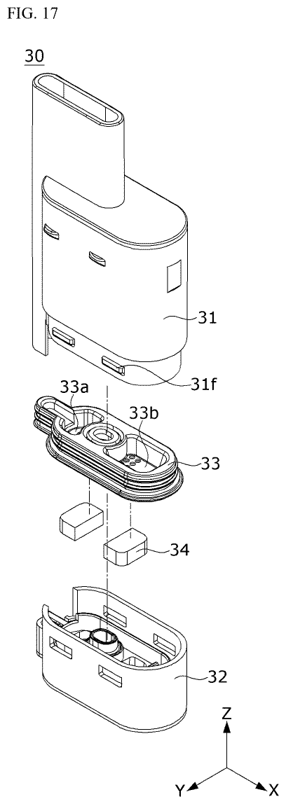

FIG. 17 is an exploded view of the cartridge 30.

Referring to FIG. 17, the cartridge 30 may include a case, a sealing member 33, and a hygroscopic body 34. The case may include a first case 31 and a second case 32. The sealing member 33 is disposed between the first case 31 and the second case 32. The hygroscopic body 34 is seated on the second case 32 and disposed below the sealing member 33.

Here, the hygroscopic body 34 serves to impregnate (contain) the aerosol generating material stored in a storing unit 31a and deliver it to the heater 22. The hygroscopic body 34 is in contact with the aerosol generating material contained in the storing unit 31a. The upper end of the hygroscopic body 34 is in contact with the aerosol generating material, and the lower end of the hygroscopic body 34 contacts the heater 22 to deliver the aerosol generating material to the heater 22. The hygroscopic body 34 may be made of a member such as a cotton fiber, a ceramic fiber, a glass fiber, or a porous ceramic. On the other hand, two hygroscopic bodies 34 may be disposed. The two hygroscopic bodies 34 may be identical in shape and size.

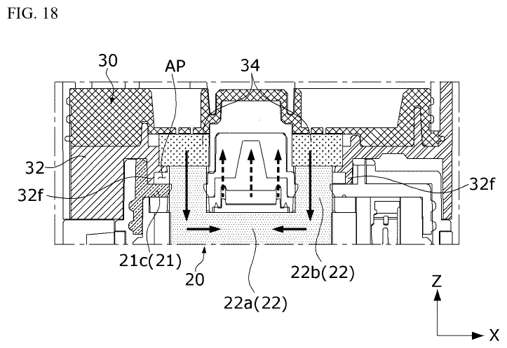

FIG. 18 is a side cross-sectional view of the periphery of the heater 22 when the cartridge 30 is connected with the heater module 20.

Referring to FIG. 15 and FIG. 18, when the cartridge 30 is mounted on the heater module 20, the hygroscopic body 34 and the heater 22 are in contact with each other, and the side wall 32f of the second case 32 of the cartridge 20 presses the heater upper sealing member 21c to be in contact therewith. Thus, the inner space AP formed by the side wall 32f of the second case 32 and the heater upper sealing member 21c is sealed to prevent leakage of the aerosol generating material supplied from the hygroscopic body 34 to the heater 22. That is, the heater module 20 may prevent leakage of the aerosol generating material between the cartridges 30.

The aerosol generating material of the hygroscopic body 34 is delivered to the heater 22. The aerosol generating material may be heated in the heater 22 to generate an aerosol.

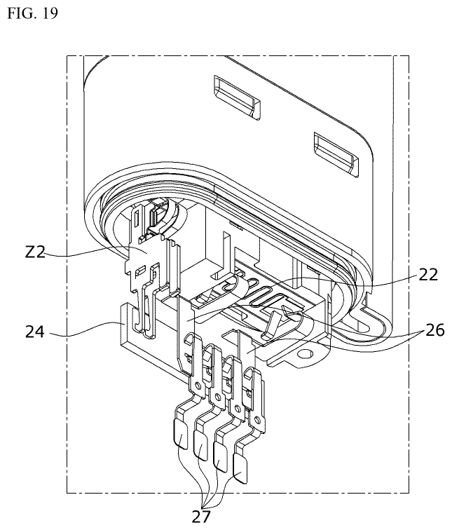

FIG. 19 is a view showing the connection terminal 27 connected to the main body 10.

Referring to FIGS. 12 and 19, the heater module 20 may include a connection terminal 27 connected to the substrate 24. The connection terminal 27 may be electrically connected to the connector CT of the main body 10 when the heater module 20 is mounted on the main body 10. This connection terminal 27 may be exposed to a portion of the main body 10 and the lower space SP of the heater module 20 into which the connector CT of the main body 10 is inserted.

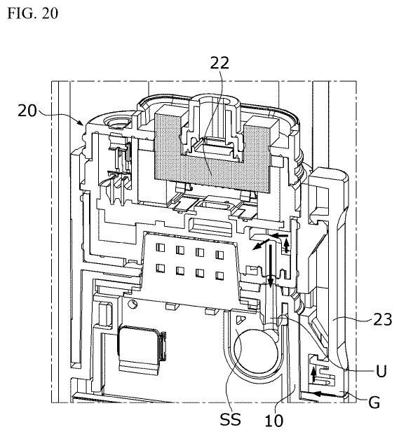

FIG. 20 is a side cross-sectional view illustrating the suction sensor SS disposed in the main body 10 and a path of the outside air communicating with the suction sensor SS.

Referring to FIG. 20, a gap G may be formed between the main body 10 and the lower end of the side cover 23 in the vertical direction. The gap G may communicate with the inside of the side cover 23. The air introduced through the gap G flows into the heater module 20 through the inside of the side cover 23.

Meanwhile, the main body 10 may include a flow path U connected to the suction sensor SS. When the heater module 20 is assembled to the main body 10, the flow path U may communicate with the inside of the heater module 20.

Certain embodiments or other embodiments of the disclosure described above are not mutually exclusive or distinct from each other. Any or all elements of the embodiments of the disclosure described above or other embodiments may be combined or used in combination with each other in their respective configuration or function.

For example, a configuration “A” described in a particular embodiment and/or figure may be combined with a configuration “B” described in another embodiment and/or in the figure. That is, even in a case where the combination between components is not directly described, it means that the combination is possible except in a case where it is described that the combination is not possible.

The above detailed description is to be considered in all respects as illustrative and not restrictive. The scope of the invention should be determined by reasonable interpretation of the appended claims, and all changes that come within the equivalent scope of the invention are intended to be embraced therein (Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art).

### DESCRIPTION OF SYMBOLS

10: Body

11: Battery

12: Control unit

13: Sensor

20: Heater module

21: Heater main body

22: Heater

23: Side cover

30: Cartridge

1. A heater module for heating aerosol generating material, the heater module comprising:
a heater main body;
a heater disposed inside the heater main body and for heating the aerosol generating material delivered from a cartridge; and
a heater upper sealing member disposed on an upper side of the heater main body,
wherein a portion of the heater is exposed above the heater upper sealing member.

2. The heater module of claim 1, further comprising:
a heater control unit,
wherein the heater control unit comprises a counting unit configured to count the number of puffs.

3. The heater module of claim 1, further comprising:
a heater control unit,
wherein the heater control unit comprises a switch that is turned on and off by an external force, and
some of the terminal units of the switch is exposed to the outside of the heater main body.

4. The heater module of claim 3,
wherein the terminal unit of the switch comprises a first terminal connected to the heater control unit, a second terminal connected to the heating control unit and spaced apart from the first terminal, and a switching terminal connected to the first terminal, and
one end of the switching terminal is connected to the first terminal and the other end thereof is disposed to be spaced apart from the second terminal, and the other end is positioned to be in contact with the second terminal by being elastically deformed by an external force.

5. The heater module of claim 4,
wherein the switching terminal comprises a receiving unit that is horizontally disposed and receives an external force in a vertical direction.

6. The method of claim 1,
wherein the heater upper sealing member comprises:
a side wall forming an accommodation space inside;
a through hole that is disposed inside the side wall and configured to communicate an upper side and a lower side of the heater upper sealing member; and
a first conduit disposed inside the side wall and configured to communicate an upper side and a lower side of the heater upper sealing member.

7. The heater module of claim 1, further comprising:
a heater control unit,
wherein the heater control unit comprises a switch that is turned on and off by an external force, and
a portion of the terminal units of the switch is exposed to the outside of the heater main body, and
wherein the heater upper sealing member comprises a switch hole disposed outside the side wall, and
the switch hole is aligned with the terminal unit of the switch.

8. The heater module of claim 6, comprising:
a first heater holder and a second heater holder that are disposed between the heater and fix the heater,
wherein the first heater holder comprises a through hole communicating the upper and lower sides of the first heater holder, and a second conduit communicating the upper and lower sides of the first heater holder, and
the through hole of the heater upper sealing member and the through hole of the first heater holder are arranged in alignment; and
the first conduit and the second conduit are arranged in alignment.

9. The heater module of claim 8,
wherein the second holder comprises a receiving groove for receiving the heater, and is made of an elastically deformable material and surrounds the heater.

10. The method of claim 6, further comprising:
a heater housing disposed inside the heater main body and disposed outside the first heater holder and the second heater holder, and a heater cover coupled to an upper side of the heater main body, and
wherein the heater upper sealing member is disposed to surround an upper portion of the heater housing, and seals between the heater cover and the heater housing.

11. The heater module of claim 10, further comprising:
a heater lower sealing member disposed to surround a lower portion of the heater housing,
wherein the heater lower sealing member seals between the main body and the heater housing.

12. A n aerosol generating device, comprising:
a main body;
a heater module removably coupled to the main body and comprising a heater for heating aerosol generating material; and
a cartridge removably coupled to the main body to retain the aerosol generating material to be delivered to the heater;
wherein the heater module comprises:
a heater main body;
a heater disposed inside the heater main body and for heating the aerosol generating material delivered from the cartridge; and
a heater upper sealing member disposed on an upper side of the heater main body,
wherein a portion of the heater is exposed above the heater upper sealing member.

13. The aerosol generating device of claim 12,
wherein the cartridge comprises a hygroscopic body, and
a portion of the heater exposed above the heater upper sealing member is in contact with the hygroscopic body.

14. The aerosol generating device of claim 12,
wherein the cartridge comprises a protruding recognition protrusion, and
the heater module further comprises a heater control unit,
wherein the heater control unit comprises a switch that is turned on and off by contact of the recognition protrusion.

15. The aerosol generating device of claim 12,
wherein the heater upper sealing member is in contact with the cartridge to form a space for receiving the aerosol generating material supplied from the cartridge and to seal the formed space.

16. The aerosol generating device of claim 12, comprising:
a side cover detachably coupled to the heater main body,
the main body comprises a flow path connected to a suction sensor disposed inside the main body, and
a gap is formed between the main body and the side cover in a vertical direction, and
when the heater module is assembled to the main body, the gap and the flow path communicate with each other.

17. The aerosol generating device of claim 14,
wherein the heater module forms a space in which a portion of the main body and a connector of the main body are inserted in a lower portion of the heater module.

18. The aerosol generating device of claim 17,
wherein the heater module comprises a connection terminal connected to the heater control unit,
the connecting terminal is exposed in a space into which a portion of the main body and the connector of the main body are inserted; and
when the heater module is assembled to the main body, the connection terminal is in electrical contact with the connector.
